(19) United States
(12) Patent Application Publication
(10) Pub. No.: US 2024/0406135 A1
(43) Pub. Date: Dec. 5, 2024

(54) DYNAMIC TIME-OF-USE NETWORK ADDRESS TRANSLATION (NAT)

(71) Applicant: International Business Machines Corporation, Armonk, NY (US)

(72) Inventors: Robert Lynch, Bedminster, NJ (US); Robert J. Brenneman, Stormville, NY (US)

(21) Appl. No.: 18/205,956

(22) Filed: Jun. 5, 2023

(51) Int. Cl. H04L 61/2553; H04L 61/2514; H04L 61/4511

(52) U.S. Cl. CPC H04L 61/2553; H04L 61/2514; H04L 61/4511

(57) ABSTRACT

In one general embodiment, a computer-implemented method includes receiving a request for dynamic naming service (DNS) resolution from a client. In response to receiving the request, a network address translation (NAT) entry is created, and the NAT entry is applied to a NAT endpoint. In response to creating the NAT entry, a NAT internet protocol (IP) address of the NAT endpoint is sent to the client. The NAT IP address has a predefined time to live (TTL). In response to the TTL expiring, the NAT entry is deleted.

### BACKGROUND

The present invention relates to utilizing network address translation (NAT), and more specifically, this invention relates to providing time-of-use NAT.

When two organizations connect together, they often have internet protocol (IP) address overlap, or do not want to expose their private IP ranges. Accordingly, the organizations may utilize NAT to allow the two separate domains to communicate without overlap and/or to avoid divulging the private IP ranges. Use of NAT requires static configuration in their systems to facilitate the communication. The static configuration often has 1-to-1 NAT mappings. For example, if there is a need to connect a /16 subnet, another /16 will be on the WAN side.

### SUMMARY

A computer-implemented method, in accordance with one embodiment, includes receiving a request for dynamic naming service (DNS) resolution from a client. In response to receiving the request, a network address translation (NAT) entry is created, and the NAT entry is applied to a NAT endpoint. In response to creating the NAT entry, a NAT internet protocol (IP) address of the NAT endpoint is sent to the client. The NAT IP address has a predefined time to live (TTL). In response to the TTL expiring, the NAT entry is deleted.

A computer program product for dynamic time-of-use NAT, in accordance with one embodiment, includes one or more computer readable storage media, and program instructions collectively stored on the one or more computer readable storage media. The program instructions include program instructions to perform the aforementioned method.

A system, in accordance with one embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a diagram of a system that implements dynamic time-of-use NAT, in accordance with one exemplary embodiment.

FIG. 4 is a diagram of a system that implements dynamic time-of-use NAT, in accordance with one exemplary embodiment.

FIG. 5 is a diagram of a system that implements dynamic time-of-use NAT, in accordance with one exemplary embodiment.

FIG. 6 is a flowchart of an exemplary method performed by a policy engine, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for providing time-of-use NAT.

In one general embodiment, a computer-implemented method includes receiving a request for dynamic naming service (DNS) resolution from a client. In response to receiving the request, a network address translation (NAT) entry is created, and the NAT entry is applied to a NAT endpoint. In response to creating the NAT entry, a NAT internet protocol (IP) address of the NAT endpoint is sent to the client. The NAT IP address has a predefined time to live (TTL). In response to the TTL expiring, the NAT entry is deleted.

In another general embodiment, a computer program product for dynamic time-of-use NAT includes one or more computer readable storage media, and program instructions collectively stored on the one or more computer readable storage media. The program instructions include program instructions to perform the aforementioned method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic time-of-use NAT code in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

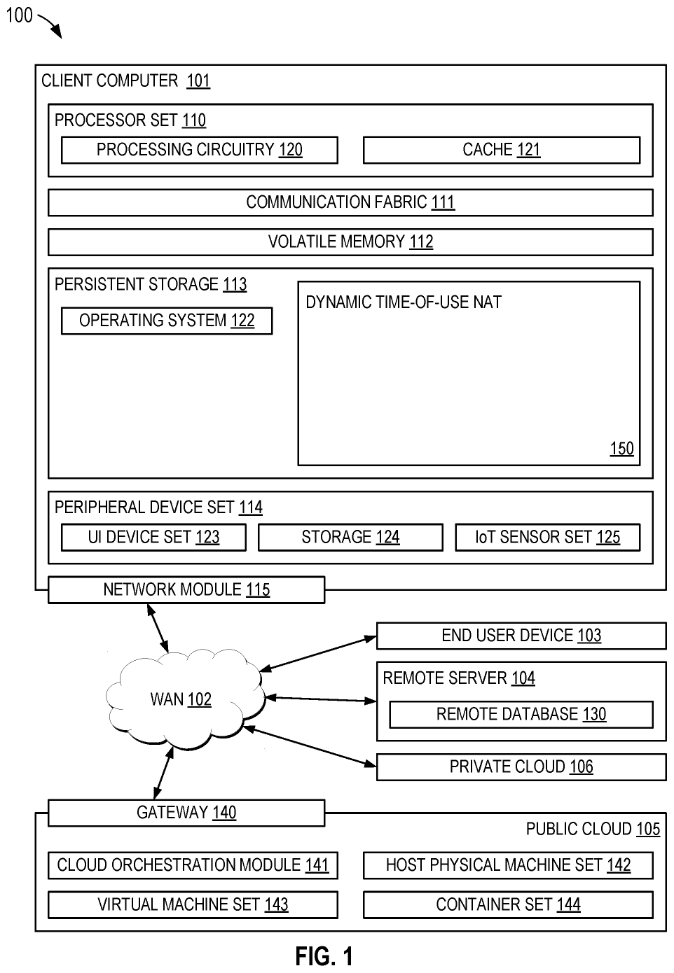

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As noted above, when two organizations connect together, they often have IP overlap, or do not want to expose their private IP ranges. Accordingly, the organizations may utilize NAT to allow the two separate domains to communicate without overlap and/or to avoid divulging the private IP ranges. Use of NAT requires static configuration in their systems to facilitate the communication. The static configuration often has 1-to-1 NAT mappings. The one-to-one NAT mapping requires large configuration and just as large IP space. For example, for large IP space, if there is a need to connect a /16 subnet, another /16 will be on the WAN side; /20 overlap needs another /20 for external mapping, and so on. This leads to large configuration files and inefficient use of IP space.

Moreover, authentication methods for the traffic are either IP based with rules, or application layer based, leading to traffic that may be let through that should not be.

In addition, IPv6 prefixes sizes make one-to-one mappings even harder.

To overcome the aforementioned problems, various embodiments use a dynamic naming service (DNS) to create dynamic NAT entries for inbound traffic based on time-of-use. A policy engine may be used to check the traffic against preconfigured rules, may perform client authentication, and can see existing sessions. Moreover, in some embodiments, multiple policy engines may be synchronized, or a single unified policy engine may be used, to streamline the process to create a generic routing encapsulation (GRE) tunnel and perform the NATs.

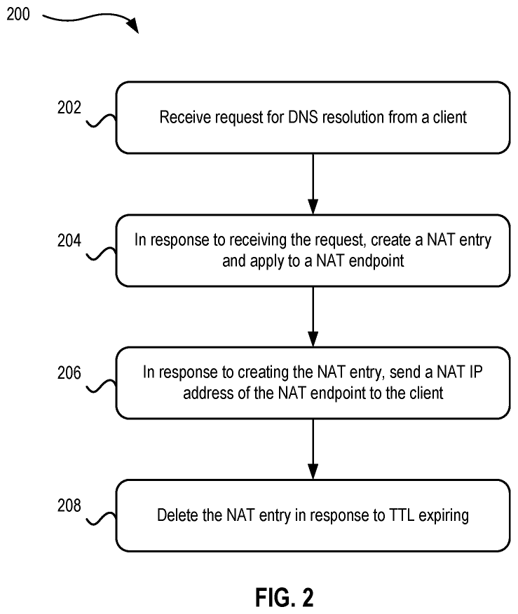

Now referring to FIG. 2, a flowchart of a method 200 is shown according to one embodiment. The method 200 may be performed in accordance with the present invention in any of the environments depicted in FIGS. 1 and 3-6, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a DNS server, a or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, where a request for dynamic naming service (DNS) resolution is received from a client. A client may be defined as a computer hardware or software device that requests access to a resource, e.g., a host, server, data center, etc. The client may be located outside of a first network on which the requested resource is accessible.

The request for DNS resolution may be of any known type. For example, the DNS resolution request may include a hostname, or any other information identifying the resource sought to be reached. The request may be received, e.g., over the Internet or any other network.

In operation 204, in response to receiving the request, a network address translation (NAT) entry is created and applied to a NAT endpoint. The client will access the requested resource within the first network through the NAT endpoint, e.g., by connecting to the IP address (or equivalently, other type of network address) specified by the NAT entry. The NAT endpoint and NAT entry may be of known type. For example, a NAT endpoint may be a firewall.

In operation 206, in response to creating the NAT entry, a NAT IP address corresponding to the NAT entry of the NAT endpoint is sent to the client.

The NAT IP address has a predefined time to live (TTL). The TTL may have any predefined duration, e.g., 60 seconds, 90 seconds, etc.

In operation 208, the NAT entry is deleted in response to the TTL expiring. Deletion of the NAT entry upon expiration of the TTL frees up the corresponding port on the NAT endpoint for a new connection. Thus, forcing the TTL ensures that resources are used efficiently, and ports are freed expeditiously for reuse.

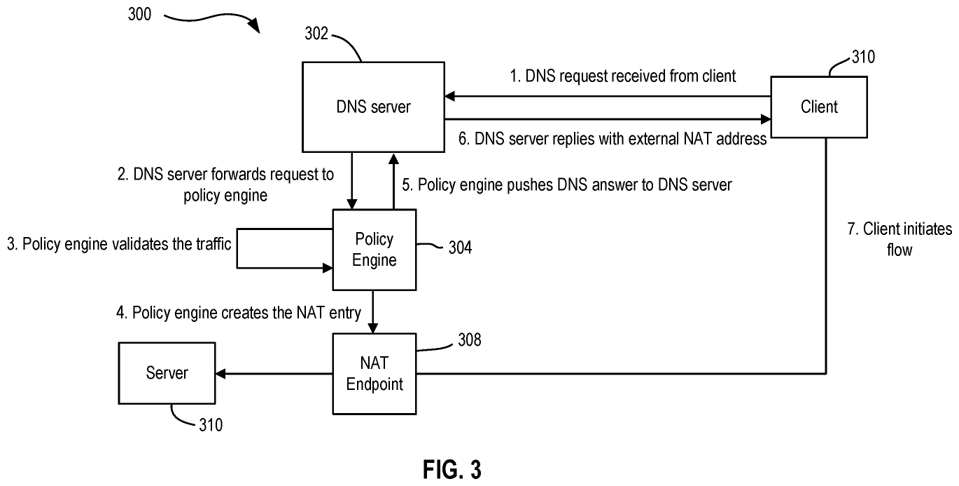

In one exemplary implementation of the method 200 of FIG. 2, when a client from outside of the first network wants to communicate inbound, the client first needs to resolve a DNS entry, and thus sends a request for DNS resolution. A DNS server receives the request resolution and a destination NAT entry is created, e.g., by the DNS server or by a policy engine. See, e.g., FIG. 3. In response to the DNS entry being created, the DNS server responds to the client with a DNS answer that has the NAT IP. The DNS answer has a predefined TTL. By including the TTL in the DNS answer, the client then knows how long that DNS answer is valid for. If the client is still using that DNS record as the end of the TTL period approaches, the client should re-request the DNS record. At a minimum, the NAT system knows it needs to keep the session alive for as long as specified in the TTL. Once the TTL expires (along with a configurable extension period if present), the destination NAT entry is deleted, and preferably only if the NAT endpoint does not have any active traffic flowing therethrough. If traffic is present, the NAT endpoint may automatically renew the DNS record, e.g., by restarting the TTL timer.

In some embodiments, the client can re-lookup the DNS record to either extend the existing NAT session or create a new one, depending on the existing state of the DNS session. Thus, the method 200 may include receiving a second request from the client for the DNS resolution; and in response to receiving the second request, extending the TTL preferably by another predefined period of time. The NAT IP address may also be resent to the client in response to the second request.

In some embodiments, the NAT endpoint itself may be used to signal the termination of the NAT. For example, the endpoint may watch for traffic and send an indication of the status of the NAT session between the client and the resource (e.g., server) accessed via the NAT endpoint. Based on the received status, the NAT session can be altered. For example, when the status indicates that the TCP session is terminated, or there is no traffic preferably for a predetermined period of time, the NAT session can be closed and the NAT entry deleted. Moreover, the status may be used to keep the DNS record alive. For example, if the client and server are actively transferring data as the DNS record is coming up on its TTL, the NAT endpoint can relay to the DNS server that traffic is still moving and to keep the DNS entry alive until the next TTL. Thus, the TTL may be extended in response to the status indicating ongoing traffic between the client and the server.

Implementing a NAT session with source and destination rule may also help a deployment be even more IP efficient, e.g., by reusing the same external IP address for different sessions.

In some embodiments, the methodology may be leveraged to implement security. A system administrator may set up a profile that dictates whether the client is allowed to reach the resource it is seeking. In one approach, a determination is made as to whether the client is authorized to connect to a destination specified in the DNS resolution request based on certificate information for the client. For example, a DNS over TLS client certificate can be used to authenticate a client. Moreover, the certificate itself or the certificate chain can be used for authentication, depending on the configuration of the deployment. The destination specified in the DNS resolution may be the server the client is attempting to reach, a particular resource on the first network, etc.

In another approach, a determination is made as to whether the client is authorized to connect to a destination specified in the DNS resolution request based on an IP address of the client. For example, the IP address of the client, or portion thereof, may be compared to a table of authorized IP addresses (or portions thereof) and a decision to allow or deny connection may be made based on such comparison.

In preferred approaches, as described in more detail with reference to FIGS. 3-6, decisions are preferably made by a policy engine. For example, the policy engine may inspect traffic, and determine if the traffic should be allowed or denied based on its configuration. Moreover, the policy engine may be responsible for maintaining the NAT session's life. Further, a user may select from any number of variables, that would become apparent to one skilled in the art after reading the present disclosure, when configuring the policy engine. For example, one variable may make the system ‘wide open’ to accept all traffic. Another variable may configure the system to apply predefined levels of authorization based on source IP; based on certificates, e.g., a DNS over TLS client certificate or certificate chain; etc.

More details about exemplary operation of the policy engine within the overall system are provided in the descriptions of FIGS. 3-6, below.

FIG. 3 depicts a system 300 that implements dynamic time-of-use NAT, in accordance with one exemplary embodiment. As an option, the present system 300 may be implemented in conjunction with features from any other embodiment listed herein, such as those described with reference to the other FIGS. Of course, however, such system 300 and others presented herein may be used in various applications and/or in permutations which may or may not be specifically described in the illustrative embodiments listed herein. Further, the system 300 presented herein may be used in any desired environment.

The system 300 includes a DNS server 302 and a policy engine 304. The DNS server 302 receives a DNS request from a client 306, and in response to receiving the request, forwards the request to the policy engine 304. The policy engine 304 validates the request, and upon successful validation, creates a NAT entry and applies the net entry to the NAT endpoint 308. The policy engine also pushes a DNS answer to the DNS server 302. Based on the DNS answer, the DNS server 302 replies to the client 306 with the external NAT address. The client is then able to initiate a flow with the server 310 via the NAT endpoint 308.

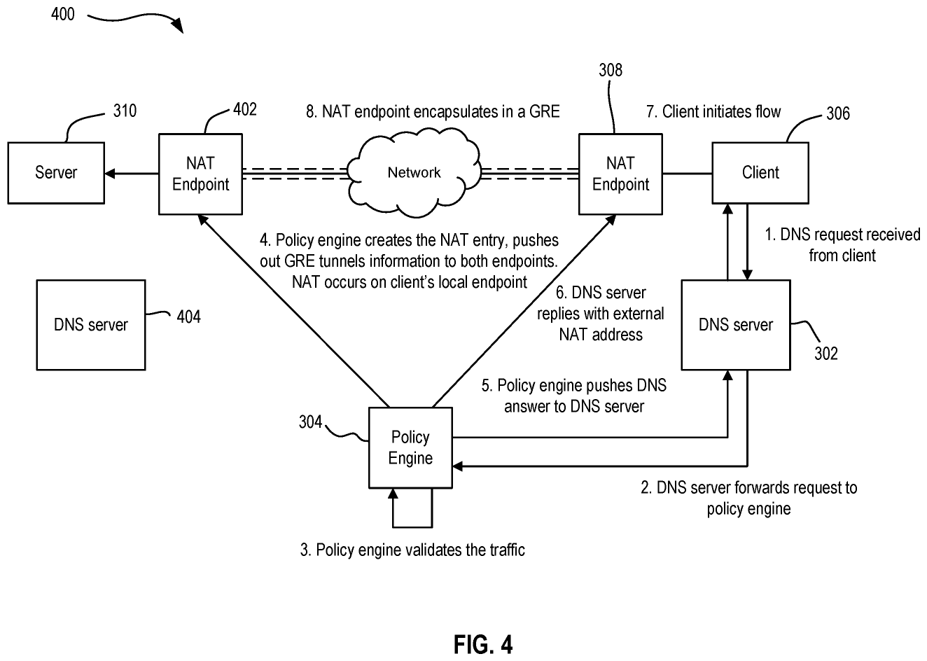

FIG. 4 depicts a system 400 that implements dynamic time-of-use NAT, in accordance with one exemplary embodiment. As an option, the present system 400 may be implemented in conjunction with features from any other embodiment listed herein, such as those described with reference to the other FIGS. Of course, however, such system 400 and others presented herein may be used in various applications and/or in permutations which may or may not be specifically described in the illustrative embodiments listed herein. Further, the system 400 presented herein may be used in any desired environment.

In this system 400, a single policy engine 304 controls multiple domains. When two domains communicate, a unified policy engine 304 inspects the traffic on either side. If the traffic is allowed, the policy engine 304 enables the NAT and create a connection, and preferably a secure connection such as a GRE tunnel (that can be encrypted with IPSec) between the two NAT endpoints 308, 402 for the traffic. For example, the policy engine 304 may create a first NAT entry and apply that to the first NAT endpoint 308, as well as create a second NAT entry, apply the second NAT entry to the second NAT endpoint 402, and establish a tunnel between the two NAT endpoints 308, 402. The remote domain may include a DNS server 404 that operates in a conventional manner. Other operations performed by the system 400 may be similar to operations described elsewhere herein, e.g., with respect to FIG. 3.

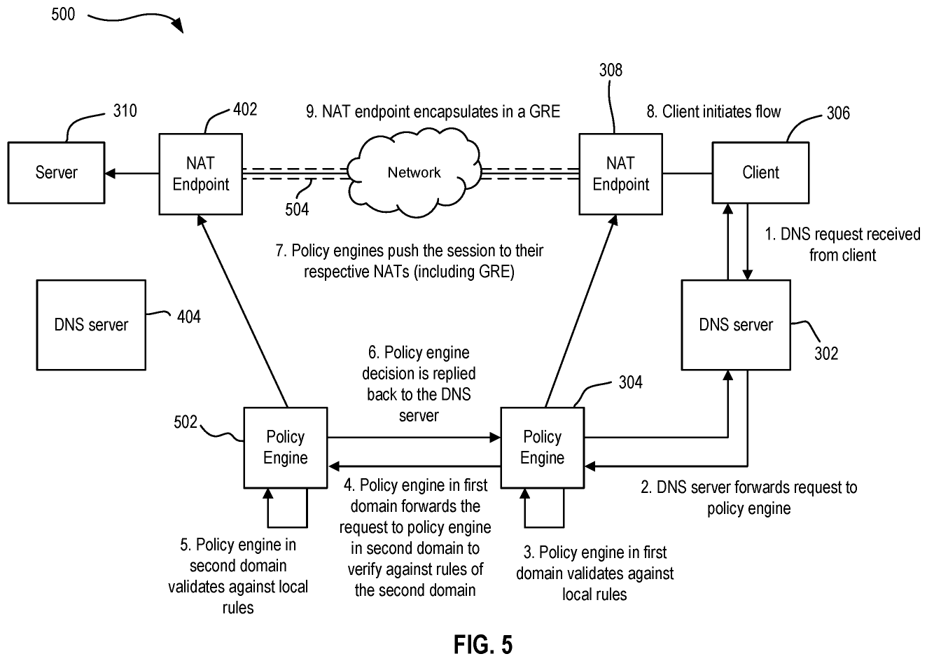

FIG. 5 depicts a system 500 that implements dynamic time-of-use NAT, in accordance with one exemplary embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

In this system 500, two different policy engines 304, 502 are synced together to allow two isolated domains to connect. The two isolated domains may, for example, be for two separate companies, two separate business units, etc. Each policy engine 304, 502 has an authorization list that both policy engines 304, 502 must agree on to forward traffic. This establishes a chain of trust. Various components of each domain may register with the respective policy engine, e.g., via Dynamic DNS over TLS. Based on client certificate, the server can register its DNS name and private IP.

Various operations performed by the system 500 may be similar to operations described elsewhere herein, e.g., with respect to FIGS. 3-4, with some modifications. For example, the first policy engine 304 sets the NAT entry for the NAT endpoint 308 located in the first domain. The first policy engine 304 sends the request to a second policy engine 502 of the second domain. The second policy engine 502 is configured to set a NAT entry for a second NAT endpoint 402 located in the second domain in response to the second policy engine validating the request. The policy engines 304, 502 establish a tunnel 504 between the two NAT endpoints 308, 402. The remote domain may include a DNS server 404 that operates in a conventional manner.

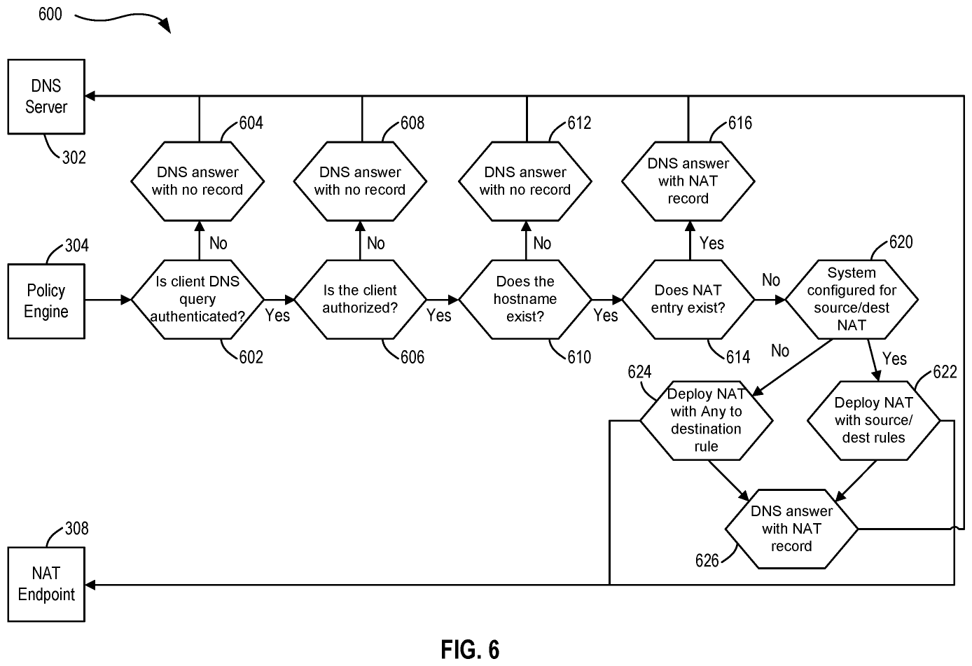

Now referring to FIG. 6, a flowchart of an exemplary method 600 performed by a policy engine is shown according to one embodiment. The method 600 may be performed in accordance with the present invention in any of the environments depicted in FIGS. 1-5, in various embodiments. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various embodiments, the method 600 may be partially or entirely performed by a DNS server, a or some other device having one or more processors therein. The processor, e.g., processing circuit(s), chip(s), and/or module(s) implemented in hardware and/or software, and preferably having at least one hardware component, may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where in response to receiving a request for DNS resolution from a client, the policy engine 304 determines whether the DNS request (query) is authenticated. If the request cannot be authenticated, the policy engine replies to the DNS server 302 with no record in operation 604. In operation 606, the policy engine determines whether the client is authorized, e.g., to communicate with the server, to communicate into the remote domain, etc. If the client is not authorized, the policy engine replies to the DNS server with no record in operation 608. In operation 610, the policy engine checks the host name listed in their request. If the hostname cannot be verified, e.g., the hostname does not exist, the policy engine replies to the DNS server with no record in operation 612. In operation 614, the policy engine determines whether the NAT entry exists. If the NAT entry exists, the policy engine sends the NAT record to the DNS server. See operation 616. If the entry does not exist, a determination is made as to whether the system is configured for source and destination NAT. See operation 620. If the system is configured for source and destination NAT, the NAT is deployed to the NAT endpoint 308 with source and destination rules in operation 622. If the system is not configured for source and destination NAT, the NAT is deployed in operation 624 allowing the client to reach any destination behind the NAT endpoint. In operation 626, the policy engine replies to the DNS server with the resulting NAT record.

The foregoing method 600 is just one of many possible permutations of the operation of the policy engine.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving a request for dynamic naming service (DNS) resolution from a client;
in response to receiving the request, creating a network address translation (NAT) entry and applying the NAT entry to a NAT endpoint;
in response to creating the NAT entry, sending a NAT internet protocol (IP) address of the NAT endpoint to the client, wherein the NAT IP address has a predefined time to live (TTL); and
in response to the TTL expiring, deleting the NAT entry.

2. The computer-implemented method of claim 1, comprising receiving a second request from the client for the DNS resolution; and in response to receiving the second request, extending the TTL.

3. The computer-implemented method of claim 1, comprising receiving from the NAT endpoint an indication of status of a NAT session between the client and a server accessed via the NAT endpoint; and altering the NAT session based on the status.

4. The computer-implemented method of claim 3, wherein the TTL is extended in response to the status indicating ongoing traffic between the client and the server.

5. The computer-implemented method of claim 3, wherein the NAT entry is deleted in response to the status indicating termination of a connection from the client.

6. The computer-implemented method of claim 1, comprising determining whether the client is authorized to connect to a destination specified in the DNS resolution request based on certificate information for the client.

7. The computer-implemented method of claim 1, comprising determining whether the client is authorized to connect to a destination specified in the DNS resolution request based on an IP address of the client.

8. The computer-implemented method of claim 1, comprising creating a second NAT entry; applying the second NAT entry to a second NAT endpoint; and establishing a tunnel between the two NAT endpoints.

9. The computer-implemented method of claim 8, wherein a single policy engine sets both NAT entries.

10. The computer-implemented method of claim 1, wherein a first policy engine sets the NAT entry for the NAT endpoint located in a first domain, wherein the first policy engine sends the request to a second policy engine of a second domain, wherein the second policy engine is configured to set a NAT entry for a second NAT endpoint located in the second domain in response to validating the request by the second policy engine, wherein the policy engines establish a tunnel between the two NAT endpoints.

11. A computer program product for dynamic time-of-use network address translation (NAT), the computer program product comprising:
one or more computer readable storage media, and program instructions collectively stored on the one or more computer readable storage media, the program instructions comprising:
program instructions to receive a request for dynamic naming service (DNS) resolution from a client;
program instructions to, in response to receiving the request, create a NAT entry and apply the NAT entry to a NAT endpoint;
program instructions to, in response to creating the NAT entry, send a NAT internet protocol (IP) address of the NAT endpoint to the client, wherein the NAT IP address has a predefined time to live (TTL); and
program instructions to, in response to the TTL expiring, delete the NAT entry.

12. The computer program product of claim 11, comprising program instructions to receive a second request from the client for the DNS resolution; and program instructions to extend the TTL in response to receiving the second request.

13. The computer program product of claim 11, comprising program instructions to receive from the NAT endpoint an indication of status of a NAT session between the client and a server accessed via the NAT endpoint; and program instructions to alter the NAT session based on the status.

14. The computer program product of claim 13, wherein the TTL is extended in response to the status indicating ongoing traffic between the client and the server.

15. The computer program product of claim 13, wherein the NAT entry is deleted in response to the status indicating termination of a connection from the client.

16. The computer program product of claim 11, comprising program instructions to determine whether the client is authorized to connect to a destination specified in the DNS resolution request based on certificate information for the client.

17. The computer program product of claim 11, comprising program instructions to determine whether the client is authorized to connect to a destination specified in the DNS resolution request based on an IP address of the client.

18. The computer program product of claim 11, comprising program instructions to create a second NAT entry; program instructions to apply the second NAT entry to a second NAT endpoint; and program instructions to establish a tunnel between the two NAT endpoints.

19. The computer program product of claim 11, wherein a first policy engine sets the NAT entry for the NAT endpoint located in a first domain, wherein the first policy engine sends the request to a second policy engine of a second domain, wherein the second policy engine is configured to set a NAT entry for a second NAT endpoint located in the second domain in response to validating the request by the second policy engine, wherein the policy engines establish a tunnel between the two NAT endpoints.

20. A system, comprising:
a processor; and
logic integrated with the processor, executable by the processor, or integrated with and executable by the processor, the logic being configured to:
receive a request for dynamic naming service (DNS) resolution from a client;
in response to receiving the request, create a network address translation (NAT) entry and applying the NAT entry to a NAT endpoint;
in response to creating the NAT entry, sending a NAT internet protocol (IP) address of the NAT endpoint to the client, wherein the NAT IP address has a predefined time to live (TTL); and
in response to the TTL expiring, deleting the NAT entry.
